(19) United States
(12) Patent Application Publication
(10) Pub. No.: US 2021/0326677 A1
(43) Pub. Date: Oct. 21, 2021

(54) DETERMINATION DEVICE, DETERMINATION PROGRAM, DETERMINATION METHOD AND METHOD OF GENERATING NEURAL NETWORK MODEL

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Shogo Kamiguchi, Yokkaichi-shi, Mie (JP); Hiroshi Ueda, Yokkaichi-shi, Mie (JP); Naoki Adachi, Yokkaichi-shi, Mie (JP); Yoshihiro Hamada, Osaka-shi, Osaka (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 17/312,575

(22) PCT Filed: Nov. 29, 2019
(86) PCT No.: PCT/JP2019/046810

§ 371 Date: Jun. 10, 2021

(30) Foreign Application Priority Data
Dec. 12, 2018 (JP) 2018-232958

(51) Int. Cl. G06N 3/04; G06N 3/08; G07C 5/08; G05B 13/02

(52) U.S. Cl. CPC G06N 3/0454; G06N 3/08; B60W 50/06; G05B 13/027; G07C 5/085

(57) ABSTRACT

A determination device acquires first data and a plurality of second data that are related to a state of a vehicle and comprises a plurality of trained neural networks that are so trained as to estimate assumption data corresponding to the first data if any one of the plurality of second data is input; and a determination unit that determines correctness of the first data based on the estimation data respectively estimated by the plurality of trained neural networks and the first data.

### CROSS-REFERENCE TO RELATED APPLICATIONS

This application is the U.S. national stage of PCT/JP2019/046810 filed on Nov. 29, 2019, which claims priority of Japanese Patent Application No. JP 2018-232958 filed on Dec. 12, 2018, the contents of which are incorporated herein.

### TECHNICAL FIELD

The present disclosure relates to a determination device, a determination program, a determination method and a method of generating a neural network model.

### BACKGROUND ART

A vehicle is mounted with electronic control units (ECUs), which control on-vehicle equipment for a powertrain system to control an engine and on-vehicle equipment for a body system to control air conditioning. These ECUs are configured to transmit and receive messages by an on-board network system. In anticipation of threats caused by an attacker accessing such an on-board network system and transmitting an unauthorized frame thereto or the like, security countermeasures have been taken. A security processing method for assessing an anomaly level of a frame received by the on-board network has been proposed (Japanese Patent Application Laid-Open No. 2017-111796, for example).

The security processing method according to Japanese Patent Application Laid-Open No. 2017-111796 successively updates a predetermined model based on the information about the frames successively acquired. The assessment of the anomaly level of the frames received in the on-board network is performed by computational processing using the received information about the frames and the predetermined model. Furthermore, the predetermined model is successively updated by machine learning based on the information about the frames successively acquired.

The security processing method according to Japanese Patent Application Laid-Open No. 2017-111796 is performed by computational processing using a single predetermined model, which may make it difficult to ensure the accuracy of a computational result upon assessment of the anomaly level of the frames.

The present disclosure is made in view of such circumstances, and an object is to provide a determination device or the like that can improve the accuracy of determination of whether the state quantity data related to the state of a vehicle is correct or not.

### SUMMARY

A determination device according to one aspect of the present disclosure acquiring first data and a plurality of second data that are related to a state of a vehicle comprises: a plurality of trained neural networks that are so trained as to estimate estimation data corresponding to the first data if any one of the plurality of second data is input; and a determination unit that determines correctness of the first data based on the estimation data respectively estimated by the plurality of trained neural networks and the first data.

### Effects of Disclosure

According to one aspect of the present disclosure, it is possible to provide a determination device or the like that can improve the accuracy of determination of whether the state quantity data related to a state of a vehicle is correct or not.

### BRIEF DESCRIPTION OF THE DRAWINGS

FIG. 1 is a schematic diagram illustrating the configuration of a determination system including a determination device according to Embodiment 1.

FIG. 2 is a block diagram illustrating the configuration of the determination device.

FIG. 3 is a functional block diagram illustrating functional parts included in a control unit of the determination device.

FIG. 4 is an illustrative view of one aspect of a trained neural network.

FIG. 5 is a flowchart showing processing performed by the control unit of the determination device.

FIG. 6 is a functional block diagram illustrating functional parts included in a control unit of a determination device according to Embodiment 2 (second trained neural network).

FIG. 7 is an illustrative view of one aspect of the second trained neural network.

FIG. 8 is a flowchart showing processing performed by the control unit of the determination device.

### DETAILED DESCRIPTION OF PREFERRED EMBODIMENTS

Embodiments of the present disclosure are first listed and described. Furthermore, at least parts of the embodiments described below may arbitrarily be combined.

A determination device according to one aspect of the present disclosure acquiring first data and a plurality of second data that are related to a state of a vehicle comprises: a plurality of trained neural networks that are so trained as to estimate assumption (estimation) data corresponding to the first data if any one of the plurality of second data is input; and a determination unit that determines correctness of the first data based on the estimation data respectively estimated by the plurality of trained neural networks and the first data.

In the present aspect, when determining whether the first data (the state quantity data to be determined) is correct or not, the determination unit performs the determination based on the state quantity data to be determined and the estimation data (estimation state quantity data) respectively estimated by the plurality of trained neural networks. Accordingly, the correctness of the state quantity data to be determined can be determined more accurately than when a single trained neural network is used.

In the determination device according to one aspect of the present disclosure, an absolute value of a correlation coefficient of each of the plurality of second data and the first data is equal to or larger than a predetermined value.

In the present aspect, the absolute value of the correlation coefficient between each of the plurality of the second data (state quantity data to be compared) and the first data (state quantity data to be determined) is set to the predetermined value or more, whereby the accuracy of the determination result can be improved.

In the determination device according to one aspect of the present disclosure, the predetermined value of the absolute value of the correlation coefficient is 0.7.

In the present aspect, the predetermined value of the absolute value of the correlation coefficient is set to 0.7, whereby the determination of whether the state quantity data to be determined is correct or not can be performed by using the second data (state quantity data to be compared) having the absolute value of the correlation coefficient relative to the first data (state quantity data to be determined) being 0.7 or more. This makes it possible to improve the accuracy of the determination result.

In the determination device according to one aspect of the present disclosure, the determination unit determines that the first data is normal if the number of estimation data be included a predetermined range with reference to the first data is more than the number of estimation data be not included the predetermined range and determines that the first data is abnormal if the number of estimation data be included the predetermined range is less than the number of estimation data be not included the predetermined range.

In the present aspect, the determination is performed based on the number of estimation data (estimation state quantity data) be included (that fall within) the predetermined range with reference to the first data (state quantity data to be determined), so that the correctness of the first data (state quantity data to be determined) can be determined with accuracy.

In the determination device according to one aspect of the present disclosure, the determination unit determines a probability of correctness of the first data based on the number of estimation data be included a predetermined range with reference to the first data and the number of estimation data be not included the predetermined range.

In the present aspect, the probability on correctness of the first data (state quantity data to be determined) is determined based on the number of estimation data (estimation state quantity data) be included the predetermined range with reference to the first data (state quantity data to be determined), so that it is possible to perform appropriate processing depending on the probability.

In the determination device according to one aspect of the present disclosure, the determination unit includes a second trained neural network that is so trained as to estimate correctness of the first data if the first data and estimation data respectively estimated by the plurality of trained neural networks are input.

In the present aspect, the determination unit includes the second trained neural network, whereby the accuracy of the determination of whether the first data (state quantity data to be determined) is correct or not can be improved.

In the determination device according to one aspect of the present disclosure, the first data is a speed of the vehicle.

In the present aspect, the first data (state quantity data to be determined) is a speed of the vehicle, whereby the determination unit can determine whether the current value of the vehicle speed is correct or not.

A determination program according to one aspect of the present disclosure causing a computer to execute processing of:

acquiring first data and a plurality of second data that are related to a state of a vehicle; inputting, if any one of the plurality of second data is input, the plurality of second data acquired to a plurality of trained neural networks that are so trained as to estimate estimation data corresponding to the first data; and determining correctness of the first data based on the estimation data respectively estimated by the plurality of trained neural networks and the first data.

In the present aspect, the computer can function as the determination device.

A determination method according to one aspect of the present disclosure comprises: acquiring first data and a plurality of second data that are related to a state of a vehicle; inputting, if any one of the plurality of second data is input, the plurality of second data acquired to a plurality of trained neural networks that are so trained as to estimate estimation data corresponding to the first data; and determining correctness of the first data based on the estimation data respectively estimated by the plurality of trained neural networks and the first data.

In the present aspect, it is possible to provide the determination method that can improve the accuracy of the determination of whether the state quantity data related to the state of a vehicle is correct or not.

A method of generating a neural network model according to one aspect of the present disclosure comprises acquiring teacher data including a plurality of types of second data related to a state of a vehicle and first data related to a state of the vehicle corresponding to each of the second data; and based on teacher data for each combination between second data and first data corresponding to the second, generating for each combination a neural network model that is so trained as to output estimation data related to corresponding first data if second data is input.

In the present aspect, it is possible to provide the method of generating the neural network model that can improve the accuracy of the determination of whether the state quantity data related to the state of a vehicle is correct or not.

In the method of generating a neural network model according to one aspect of the present disclosure, a plurality of the neural network models generated are connected in parallel to each other in order that the first data and estimation data to be respectively output are compared with each other.

In the present aspect, the method of generating the plurality of neutral network models that are connected in parallel to each other are provided, whereby it is possible to provide the method of generating the neural network model that can improve the accuracy of the determination of whether the state quantity data related to the state of a vehicle is correct or not.

In the method of generating a neural network model according to one aspect of the present disclosure, the teacher data includes the first data and second data having an absolute value of a correlation coefficient relative to the first data equal to or larger than a predetermined value.

In the present aspect, the absolute value of the correlation coefficient between the first data and each of the plurality of second data is set to a predetermined value or more, whereby it is possible to provide the method of generating the neural network model that can improve the accuracy of the determination of whether the state quantity data related to the state of a vehicle is correct or not.

The present disclosure will be described below in details with reference to the drawings depicting embodiments. A determination device 6 according to the embodiments of the present disclosure will be described below with reference to the drawings. It is to be understood that the present disclosure is illustrative in all respects and not restrictive. The scope of the present disclosure is defined by the appended claims, and all changes be included the meanings and the bounds of the claims, or equivalence of such meanings and bounds are intended to be embraced by the claims.

### Embodiment 1

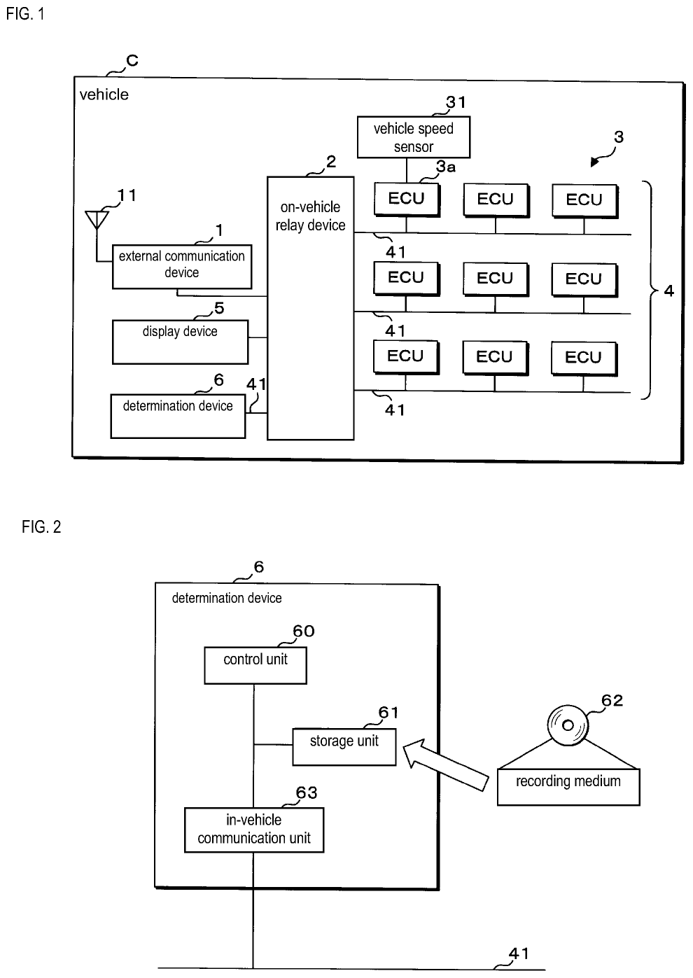

FIG. 1 is a schematic diagram illustrating the configuration of a determination system including a determination device 6 according to Embodiment 1. A vehicle C is equipped with an external communication device 1, an on-vehicle relay device 2, multiple on-vehicle ECUs 3, a display device 5 and the determination device 6. A group of these devices forms a determination system.

The vehicle C communicates with an external server, etc. (not illustrated) connected to a network outside the vehicle (not illustrated) via the external communication device 1 and thus any on-vehicle ECU 3 may be subjected to an abnormal condition by a computer virus or the like, sometimes due to unauthorized access (attack) from the outside of the vehicle. In order to address this problem, the determination system including the determination device 6 can determine whether data (data on the state of the vehicle/state quantity data) output from the abnormal on-vehicle ECU 3 is correct or not.

The external communication device 1 is a communication device for making wireless communication using a mobile communication protocol, for example, 3G, LTE, 4G, WiFi or the like, and transmits and receives data with an external server such as a program provision device (not illustrated) or the like through an antenna 11. The communication between the external communication device 1 and the external server is performed via an external network, for example, a public network, the Internet or the like.

The on-vehicle relay device 2 relays messages that are transmitted and received between these multiple on-vehicle ECUs 3. The on-vehicle relay device 2 is a gateway (relay) that exercises control over segments using communication lines 41 (CAN bus/CAN cable) for multiple systems such as a control system on-vehicle ECU 3, a security system on-vehicle ECU 3, a body system on-vehicle ECU 3, etc. and that relays communication from one on-vehicle ECU 3 to another on-vehicle ECU 3 between these segments. Alternatively, the on-vehicle relay device 2 may function as a repro master that transmits a program or data acquired from an external server such as a program provision device or the like connected to the network outside the vehicle (not illustrated) via the external communication device 1 to the on-vehicle ECU 3 (electronic control unit) mounted on the vehicle C.

The external communication device 1 is communicably connected to the on-vehicle relay device 2 and the display device 5 through a harness, for example, a serial cable or the like. The on-vehicle relay device 2 is communicably connected to the on-vehicle ECUs 3 and the determination device 6 by an in-vehicle LAN 4 according to a communication protocol, for example, a control area network (CAN) (registered trademark), the Ethernet (registered trademark) or the like.

The on-vehicle ECUs 3 are connected to actuators such as an engine, a brake, etc. or sensors that are mounted on the vehicle and are computers for controlling drive of the actuators or transferring data output from the sensors to the in-vehicle LAN 4. The on-vehicle ECUs 3 are communicably connected with one another via the in-vehicle LAN 4 and the on-vehicle relay device 2. These on-vehicle ECUs 3 include a vehicle speed ECU 3a connected to a vehicle speed sensor 31. The vehicle speed sensor 31 is a sensor for detecting the number of rotations of the vehicle wheel, for example, and detects data related to the number of rotations in time series and outputs the data to the vehicle speed ECU 3a. The vehicle speed ECU 3a acquires the data output from the vehicle speed sensor 31, converts the acquired data to a value of the vehicle speed, for example, and transmits the value as data related to the vehicle speed to another on-vehicle ECU 3 and the determination device 6 via the in-vehicle LAN. Furthermore, some of the multiple on-vehicle ECUs 3 output state quantities each having a correlation coefficient equal to or larger than a predetermined value relative to a vehicle speed. The details will be described later.

The display device 5 is a human machine interface (HMI) device such as a car navigation display, for example. The display device 5 is communicably connected to an input-output interface (I/F) of the on-vehicle relay device 2 through a harness such as a serial cable or the like. The display device 5 displays data or information output from the on-vehicle relay device 2 or the determination device 6. The connection between the display device 5 and the on-vehicle relay device 2 may be one via the in-vehicle LAN 4 though not limited to one via the input-output I/F or the like.

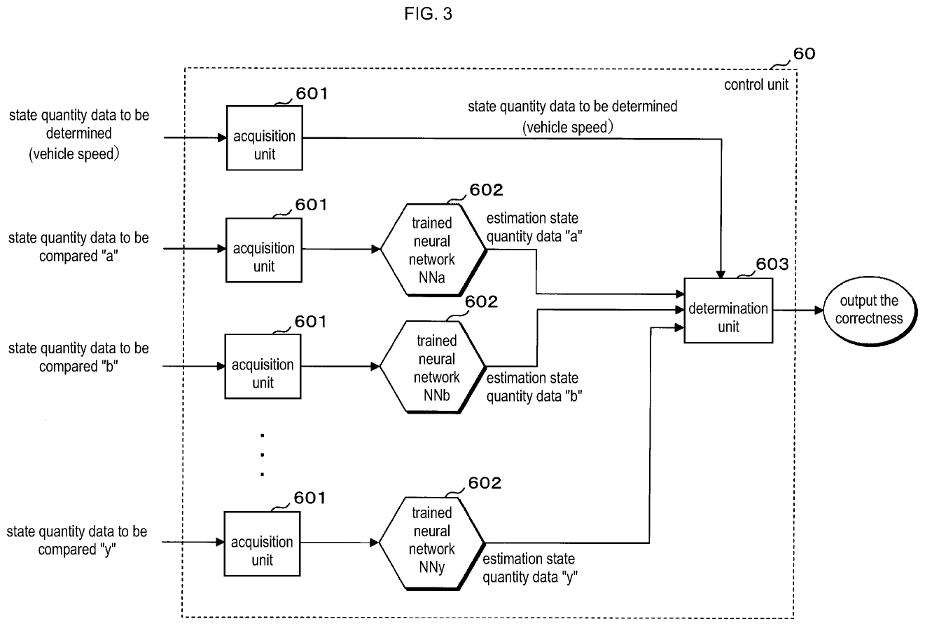

FIG. 2 is a block diagram illustrating the configuration of the determination device 6. FIG. 3 is a functional block diagram illustrating functional parts included in a control unit 60 of the determination device 6. The determination device 6 includes the control unit 60, a storage unit 61 and an in-vehicle communication unit 63.

The storage unit 61 is composed of a volatile memory element such as a random access memory (RAM) or the like or a nonvolatile memory element such as a read only memory (ROM), an electrically erasable programmable ROM (EEPROM), a flash memory or the like, and stores in advance a control program and data to be referred when the control program is being processed. The control program stored in the storage unit 61 may be read from a recording medium 62 that is readable by the determination device 6 and stored therein. Alternatively, the control program may be downloaded from an external computer (not illustrated) connected to a communication network (not illustrated) and stored in the storage unit 61. The storage unit 61 stores actual files (trained model files) that form of a trained neural network 602 (NN).

The trained model files are included in the control program.

The in-vehicle communication unit 63 is an input-output interface (CAN transceiver or Ethernet PHY part) by means of a communication protocol, for example, a CAN, the Ethernet or the like. The control unit 60 mutually communicates with the on-vehicle equipment such as the on-vehicle ECUs 3, the on-vehicle relay device 2 or the like that are connected to the in-vehicle LAN 4 via the in-vehicle communication unit 63.

The control unit 60 is composed of a central processing unit (CPU), an micro processing unit (MPU), a graphics processing unit (GPU) or the like, and reads and executes the control program, data and trained model file that are stored in the storage unit 61 in advance to thereby perform various control processing, arithmetic processing, etc.

The control unit 60 executes the control program to thereby act as an acquisition unit 601 for acquiring data received via the in-vehicle communication unit 63. This data includes state quantity data to be determined (first data) such as data on a vehicle speed output from the vehicle speed ECU 3a, for example, and data on multiple state quantities (multiple state quantity data to be compared (second data)) each having a correlation coefficient equal to or larger than a predetermined value relative to the state quantity data to be determined.

The control unit 60 reads out the trained model file to function as the trained neural network 602 and estimates estimation state quantity data (estimation data) based on the acquired state quantity data to be compared.

The control unit 60 executes the control program to thereby act as a determination unit 603 for determining whether the state quantity data to be determined is correct or not based on the state quantity data to be determined and the estimation state quantity data.

The determination device 6 is provided separately from the on-vehicle relay device 2 and is communicably connected to the on-vehicle relay device 2 through the communication line 41, though the configuration of the determination device 6 is not limited thereto. The determination device 6 may be incorporated in the on-vehicle relay device 2 and function as one functional part of the on-vehicle relay device 2. That is, the on-vehicle relay device 2 includes a control unit (not illustrated) and a storage unit (not illustrated) similarly to the determination device 6, and the control unit of the on-vehicle relay device 2 may function as the determination device 6 by executing the control program. Alternatively, the determination device 6 may be configured as one functional part of the body ECU for controlling the entire vehicle C or the vehicle computer. Alternatively, the determination device 6 may be included in an external server such as a cloud server or the like communicably connected to the vehicle C via the external communication device 1.

As described above, the control unit 60 executes the control program to thereby function as the acquisition unit 601, the trained neural network 602 and the determination unit 603, and these units are shown as functional parts in FIG. 3.

The acquisition unit 601 acquires state quantity data to be determined such as a vehicle speed and multiple state quantity data to be compared, to allow the control unit 60 to receive these data input. In terms of a physical layer, these data are input to the control unit 60 via the in-vehicle communication unit 63. The control unit 60 executes the control program using the state quantity data to be determined and multiple state quantity data to be compared that are input as an argument to the control program, for example, to thereby function as the acquisition unit 601, the trained network and the determination unit 603.

The state quantity data to be determined such as a vehicle speed or the like is data transmitted from the vehicle speed ECU 3a, for example. The multiple state quantity data to be compared are data transmitted from an imaging unit, a light detection and ranging (Lidar) for detecting respective state quantity data to be compared or data transmitted from the on-vehicle ECUs 3 connected to the various sensors, and are state quantities indicating the states related to traveling of the vehicle C, for example, engine revolutions, motor revolutions, a steering wheel angle, acceleration or the like. Alternatively, the multiple state quantity data to be compared may be data or types of messages flowing in the in-vehicle LAN 4 or an analysis result of a traffic based on the data received by the on-vehicle relay device 2, or may be data transmitted from this on-vehicle relay device 2. The multiple state quantity data to be compared may be data formed of a single value or time-series data including multiple values in time series. The multiple state quantity data to be compared that are acquired by the determination device 6 indicate desirably different types of state quantities, for example, engine revolutions, motor revolutions or the like as described above. The use of different types of the multiple state quantity data to be compared that are acquired by the determination device 6 allows determination of the correctness of the state quantity data to be determined from the viewpoints according to the types and can improve the accuracy of the determination. It is noted that all the multiple state quantity data to be compared that are acquired by the determination device 6 need not be different in type, and some of the multiple state quantity data to be compared corresponding to a part of the multiple state quantity data to be compared may be of the same type. Alternatively, the multiple state quantity data to be compared may entirely be of the same type.

The absolute value of a correlation coefficient between each of the state quantity data to be compared and the state quantity data to be determined is a predetermined value or more. In other words, the absolute value of the correlation coefficient of each of the state quantity data to be compared relative to the state quantity data to be determined is equal to or larger than the predetermined value. The predetermined value may be 0.7, for example. Setting the predetermined value to 0.7 enables the use of the state quantity data to be compared with a state quantity having a relatively high degree of association relative to the state quantity data to be determined. When the estimation accuracy is improved, the predetermined value is desirably set to 0.9. More preferably, the predetermined value may be set to 0.97. The correlation coefficient can be calculated by using, for example, the formula (correlation coefficient=the covariance between the value of the state quantity to be determined and the value of the state quantity to be compared/(the standard deviation of the value of the state quantity to be determined×the standard deviation of the value of the state quantity to be compared)). The absolute value of each of the correlation coefficients is set to the predetermined value or more, whereby the state quantity data to be compared of the state quantity having a relatively high degree of association in a positive correlation and a negative correlation can be used. In other words, in the case where the state quantity data to be compared indicates a negative correlation, the correlation coefficient relative to the state quantity data to be determined is a negative (minus) value, by which −1 is multiplied, enabling the use of it as the state quantity data to be compared having a positive correlation.

The state quantity data to be compared that are acquired by the acquisition unit 601, i.e., the state quantity data to be compared that are input to the control unit 60 (each state quantity data to be compared as an argument to the control program) are respectively input to trained neural networks 602 (trained NNs) depending on the types of the state quantity data to be compared. Though the details will be described later, each of the trained neural networks 602 is so trained as to estimate estimation state quantity data corresponding to the state quantity data to be determined in accordance with the state quantity data to be compared that is input. As illustrated in FIG. 3, the trained neural networks 602 are connected in parallel to each other. Accordingly, the estimation state quantity data that are respectively estimated by the trained neural networks 602 are output to the determination unit 603, so that a data flow topology is formed by the trained neural networks 602 connected in parallel to each other.

As shown in FIG. 3, a trained neural network 602a receives an input of state quantity data to be compared “a” corresponding thereto, and predicts estimation state quantity data “a” corresponding to the state quantity data to be determined and outputs the data to the determination unit 603. Similarly, a trained neural network 602b receives an input of state quantity data to be compared “b” corresponding thereto, and predicts estimation state quantity data “b” corresponding to the state quantity data to be determined and outputs the data to the determination unit 603.

To the individual trained neural networks 602, different types of state quantity data to be compared are input. Each of the trained neural networks 602 is so trained as to estimate the estimation state quantity data as being equal to the corresponding state quantity data to be determined, based on the input state quantity data to be compared. Depending on the types of the state quantity data to be compared and differences between the correlation coefficients, etc., however, the values of the estimation state quantity data that are respectively estimated by the trained neural networks 602 vary.

The estimation state quantity data respectively estimated by the trained neural networks 602 and the state quantity data to be determined acquired by the acquisition unit 601 are input to the determination unit 603. The determination unit 603 determines whether the state quantity data to be determined is correct or not based on the respective estimation state quantity data and the state quantity data to be determined that are input. By determining the correctness of the state quantity data to be determined, whether unauthorized processing is present or not through the processing until the state quantity data to be determined is acquired, that is, whether unauthorized processing is present or not can be determined.

For the value of the state quantity to be determined included in the state quantity data to be determined, the determination unit 603 derives the number of estimation state quantity data be included a predetermined range with reference to the value of the state quantity to be determined. The predetermined range with reference to the value of the state quantity to be determined is a range within plus or minus 10% from this value and is a threshold range allowable for determining the accuracy of the value of the state quantity to be determined. For example, in the case where the state quantity data to be determined is data on a vehicle speed, and the value of the state quantity to be determined (vehicle speed) is 60 Km, the threshold range (predetermined range) is from 54 Km to 66 Km, assuming that the predetermined range (the threshold range) with reference to the value of the state quantity to be determined is plus or minus 10% of the value.

The determination unit 603 derives for each estimation state quantity data the number of estimation state quantity data be included the threshold range and the number of estimation state quantity data be not included the threshold range (outside the threshold range) and determines the correctness of the state quantity data to be determined (the presence or absence of unauthorized processing) by comparing these numbers. In other words, if the number of estimation state quantity data be included the threshold range is more than the number of estimation state quantity data be not included the threshold range, the determination unit 603 determines that the state quantity data to be determined is normal. If the number of estimation state quantity data be included the threshold range is less than the number of estimation state quantity data be not included the threshold range, the determination unit 603 determines that the state quantity data to be determined is abnormal.

When performing the determination, the determination unit 603 may determine that the state quantity data to be determined is normal if the number of estimation state quantity data be included the threshold range is equal to or more than half of the total number of estimation state quantity data estimated. The determination unit 603 may determine that the state quantity data to be determined is abnormal if the number of estimation state quantity data be included the threshold range is less than the half of the total number of estimation state quantity data estimated.

The determination unit 603 may derive the probability on the correctness of the state quantity data to be determined based on the ratio between the number of estimation state quantity data be included the threshold range and the number of estimation state quantity data be not included the threshold range. The probability is determined based on the value obtained by dividing the number of estimation state quantity data be included the threshold range by the total number of estimation state quantity data estimated, for example. In other words, if the total number of estimation state quantity data estimated is ten and the number of estimation state quantity data be included the threshold range is seven, the probability of the state quantity data to be determined being normal is 70% (70=(7/10)×100). Here, it goes without saying that the probability of the state quantity data to be determined being abnormal is 30% (30=100−70).

The determination unit 603 may be configured to output the correctness of the state quantity data to be determined or the probability on the correctness of the state quantity data to be determined as a determination result and to store it in the storage unit 61, transmit it to the display device 5 or transmit it to an external server outside the vehicle via the on-vehicle relay device 2 and the external communication device 1.

As such, the multiple trained neural networks 602 respectively corresponding to different types of multiple state quantity data to be compared are provided, and the determination unit 603 uses the estimation state quantity data respectively estimated by the trained neural networks 602. This makes it possible to accurately determine the correctness of the state quantity data to be determined, that is, the presence or absence of unauthorized processing related to the state quantity data to be determined even if any abnormality occurs in any one of the state quantity data to be compared or if any abnormality occurs in the processing by any one of the trained neural networks 602. That is, even if any one of the on-vehicle ECUs 3 that outputs the state quantity data to be compared becomes abnormal due to being attacked by a computer virus or the like, the correctness of the state quantity data to be determined can be determined by using the state quantity data to be compared that is output from another normal on-vehicle ECU 3. Alternatively, even if any one of the trained neural networks 602 is attacked by a computer virus or the like and becomes abnormal, the correctness of the state quantity data to be determined can be determined based on the estimation state quantity estimated by another normal trained neural network 602.

When the state quantity data to be determined is compared with the multiple estimation state quantity data estimated, the comparison is performed depending on whether or not each estimation state quantity data falls within the predetermined range (threshold range) with reference to the state quantity data to be determined, which can compensate for variation in the estimation state quantity data estimated by the individual trained neural networks 602 and enables accurate determination of the correctness of the state quantity data to be determined.

The predetermined value of the absolute value of the correlation coefficient is set to, for example, 0.7, whereby only the state quantity data to be compared having the absolute value of the correlation coefficient with the state quantity data to be determined of 0.7 or more can be used for determination of the correctness of the state quantity data to be determined, which can improve the accuracy of the determination result.

Though the data on a vehicle speed is exemplified as the state quantity data to be determined, the state quantity data to be determined is not limited thereto. The state quantity data to be determined includes state quantities indicating the states of a vehicle C, for example, engine or motor revolutions, the drive amount of the brake, a steering wheel angle, etc. Here, the state quantity data to be compared has a correlation coefficient the absolute value of which is a predetermined value or more relative to the exemplified state quantity data to be determined.

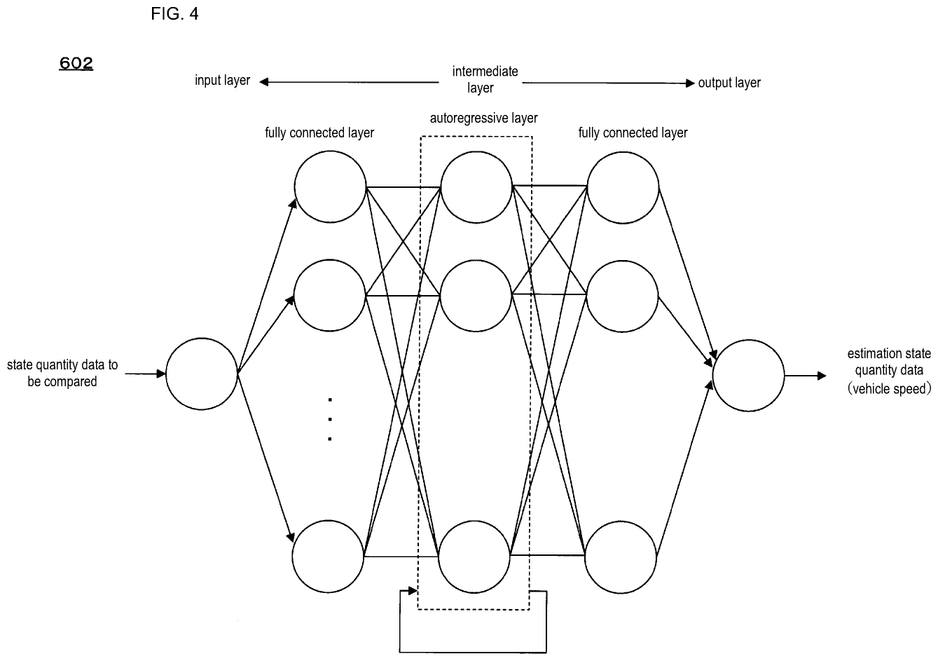

FIG. 4 is an illustrative view of one aspect of the trained neural network 602. The trained neural network 602 includes an input layer, an intermediate layer and an output layer. The intermediate layer is composed of multiple layers (deep neural network) including a fully connected layer and an autoregressive layer, for example.

The input layer is composed of a single node (neuron), for example, and the input layer receives an input of the state quantity data to be compared having a correlation coefficient being a predetermined value or more relative to the state quantity data to be determined such as a vehicle speed, for example.

The fully connected layer is composed of multiple, e.g., 100 nodes that are respectively connected to all the preceding and succeeding nodes. The trained neural network 602 includes two fully connected layers, and these two fully connected layers are positioned before and after an autoregressive layer.

The autoregressive layer is composed of multiple, e.g., 100 nodes and outputs the results to its own layer as well as to the next layer in the forward direction. Accordingly, multiple values output in time series can be provided as time series data. The neural network including such an autoregressive layer is also called a recurrent neural network and is mounted as a long short term memory (LSTM) model. Though the intermediate layer includes the autoregressive layer, the configuration of the intermediate layer is not limited thereto. The intermediate layer may be composed of multiple fully connected layers without including an autoregressive layer. If the autoregressive layer is not included in the intermediate layer, computation is performed by instantaneous values of the input values.

The output layer is composed of a single node (neuron), for example and outputs estimation state quantity data estimated from the input quantity data to be compared. If the state quantity data to be determined is data related to a vehicle speed, the estimation state quantity data is also data related to a vehicle speed.

The neural network (untrained neural network) configured as described above receives an input of teacher data (training data) and is trained to thereby generate a trained neural network 602 (neural network model). In the recurrent neural network, such training is performed by using a backpropagation through time (BPTT) algorithm, for example.

The teacher data is a combination of two state quantity data (data set of a problem (the state quantity data to be compared) and an answer (the state quantity data to be determined)) between the state quantity data to be compared output from the various sensors or devices that are mounted on the vehicle C and the state quantity data to be determined (a vehicle speed, for example) obtained at the same time as the time point when the state quantity data to be compared is output. In other words, the state quantity data to be compared and the state quantity data to be determined are a set of data associated with each other by having the same time point of being output.

The teacher data includes combinations of two state quantity data at multiple time points. In the teacher data, the combinations of two state quantity data may be data sorted as time series data. In other words, when the neural network 602 is trained by the teacher data, data of the combinations of two state quantity data included in the teacher data may be sequentially read in time series. By thus using the teacher data in time series, the neural network including the autoregressive layer can be trained by the above-described BBTT algorithm. By using the time series data, the neural network 602 receives an input of the state quantity data to be compared that correlates with the state quantity data to be determined such as a vehicle speed at one time point (time t=n) in the teacher data, and estimates estimation data corresponding to the state quantity data to be determined such as the vehicle speed at the next time point (time t=n+1). While repeatedly calculating the differences between the estimated estimation data and the state quantity data to be determined such as a vehicle speed as a correct answer value and calculating learning errors by using all the calculated differences, the neural network 602 is trained such that each learning error is minimized, for example.

The same time point is not limited to the case where the time point when the state quantity data to be compared is output and the time point when the state quantity data to be determined is output are completely the same. These time points may be different within a tolerance allowed when computation is performed using the trained neural network 602. Alternatively, the state quantity data to be compared and the state quantity data to be determined are output at predetermined cycles, and the state quantity data to be compared and the state quantity data to be determined that are output within the same cycle may be used as data in the same time point.

Multiple teacher data are prepared for respective types of the state quantity data to be compared. Neural network models (untrained neural networks) each having the same configuration respectively receive inputs of the multiple teacher data and are trained to thereby generate multiple trained neural networks 602 respectively corresponding to the types of the state quantity data to be compared. The multiple trained neural networks 602 generated are connected in parallel to each other as illustrated in FIG. 3.

Each of the values included in the state quantity data to be compared, which is an input value (explanatory variable) for the neural network, may be a value normalized to change from 0 to 1 by being divided by the maximum value of these values. The neural network may be configured as a linear regression model, for example. The linear regression model estimates the state quantity data to be determined as a response variable (y: output value) from the state quantity data to be compared as an explanatory variable (x: input value) and is a model for performing an estimation using a regression equation (y=b1·x1+b2·x2+b3·x3+ . . . +bk·xk+e) with the use of a partial regression coefficient (b/weighting factor) and an error (e/bias) as coefficients of the explanatory variable. The weighting factor and bias can be derived by employing backpropagation and gradient descent in which a square error function is used as a loss function, for example, and the output value from the loss function (the difference between the output layer and the answer) is minimized.

A method of generating the trained neural network 602 (neural network model) as described above follows the following processing. First, first data (the state quantity data to be determined such as a vehicle speed, for example) concerning the state of a vehicle C is assumed as answer data while second data (the state quantity data to be compared) having the absolute value of the correlation coefficient relative to the first data equal to or larger than a predetermined value is assumed as problem data. Multiple teacher data are prepared each being composed of datasets including combinations of problem data and answer data and each being different in types of the second data as problem data. Then, multiple untrained neural networks having the same number as the number of teacher data are prepared. Learning processing for training with teacher data such that the estimation data corresponding to the first data as an answer to the input second data based on the input second data is estimated is performed on the untrained neural networks successively by using the multiple teacher data. Then, multiple trained neural networks 602 respectively corresponding to the multiple teacher data are generated, and connected in parallel to each other to allow the respective estimation data estimated to be compared with each other.

When the trained neural networks 602 thus generated receives an input of the state quantity data to be compared through the input layer, it outputs the estimation state quantity data estimated to become the state quantity data to be determined corresponding to the state quantity data to be compared from the output layer. As described above, the intermediate layer includes an autoregressive layer. If multiple state quantity data to be compared in time series are input as time series data through the input layer, the value input to the autoregressive layer at the present time point and the value output from the autoregressive layer at the previous time point are added to be a value output from the autoregressive layer at the present time point. By thus using the autoregressive layer, the estimation state quantity corresponding to the state quantity data to be determined can accurately be estimated based on the state quantity data to be compared output in time series during traveling of the vehicle C.

In the present embodiment, though one type of the state quantity data to be compared is input to a single trained neural network 602, the number of types is not limited thereto. Multiple types of the state quantity data to be compared obtained at the same time point may be input to a single trained neural network 602, and the estimation data corresponding to the state quantity data to be determined in accordance with the input multiple types of the state quantity data to be compared may be estimated and output. When multiple types of the state quantity data to be compared are input, the number of nodes in the input layer may have the same number as the number of the multiple types of the state quantity data to be compared. Alternatively, when multiple types of the state quantity data to be compared are input, a value obtained by adding the respective values included in the multiple types of the state quantity data to be compared or by multiplying the respective values by a predetermined coefficient and merging them (merging processing) may be input. Note that, if multiple types of the state quantity data to be compared are input to a single trained neural network 602, the trained neural network 602 is generated by being trained with the use of the teacher data including datasets of combinations of multiple types of the state quantity data to be compared and the state quantity data to be determined.

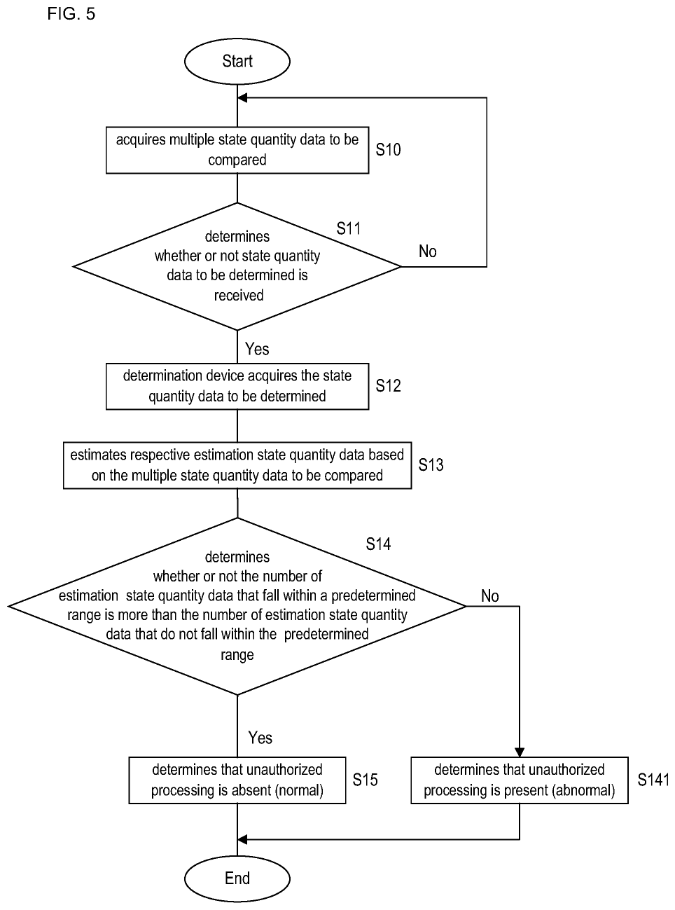

FIG. 5 is a flowchart showing processing performed by the control unit 60 of the determination device 6. The control unit 60 of the determination device 6 constantly performs the following processing in a state where the vehicle C is started.

The control unit 60 of the determination device 6 acquires multiple state quantity data to be compared (S10). The control unit 60 acquires multiple state quantity data to be compared indicating the state of the vehicle C transmitted from the on-vehicle ECU 3, the on-vehicle relay device 2 or the like and stores the acquired data in the storage unit 61. The control unit 60 may store in the storage unit 61 each of the acquired state quantity data to be compared in association with the time or the time point obtained when the data is acquired.

The control unit 60 of the determination device 6 determines whether or not state quantity data to be determined is received (S11). The control unit 60 determines whether the state quantity data to be determined such as a vehicle speed, for example, is received or not. If the state quantity data to be determined is data on the vehicle speed, the data is transmitted from the vehicle speed ECU 3a, for example.

If not receiving the state quantity data to be determined (S11: NO), the control unit 60 of the determination device 6 performs loop processing to execute the processing at step S10 again. If not receiving the state quantity data to be determined, the control unit 60 executes the processing at step S10 again to acquire multiple state quantity data to be compared that have been transmitted from the on-vehicle ECU 3, the on-vehicle relay device 2 or the like after the previous processing at step S10 and stores the acquired data in the storage unit 61. This storage may be performed by overwriting the state quantity data to be compared previously acquired.

If receiving the state quantity data to be determined (S11: YES), the control unit 60 of the determination device 6 acquires the state quantity data to be determined (S12). If receiving the state quantity data to be determined, the control unit 60 acquires the state quantity data to be determined and stores the data in the storage unit 61. The control unit 60 may store the acquired state quantity data to be determined in association with the time point or the time when the data is acquired (also referred to as an acquisition time point or an acquisition time) in the storage unit 61. The control unit 60 periodically performs the processing at step S11, so that the state quantity data to be determined and the multiple state quantity data to be compared can be used as data acquired at the same time point. Alternatively, the control unit 60 stores the acquired state quantity data to be determined and multiple state quantity data to be compared in association with the acquisition time point or the acquisition time, so that the state quantity data to be determined and the multiple state quantity data to be compared may be defined based on the acquisition time point or the acquisition time.

The control unit 60 of the determination device 6 estimates respective estimation state quantity data based on the multiple state quantity data to be compared (S13). The control unit 60 functions as the trained neural networks 602 by executing the control program and estimates the respective estimation state quantity data by inputting the multiple state quantity data to be compared to the trained neural networks 602 respectively corresponding to these state quantity data to be compared.

The control unit 60 of the determination device 6 determines whether or not the number of estimation state quantity data be included a predetermined range is more than the number of estimation state quantity data be not included the predetermined range (S14). The control unit 60 derives the number of estimation state quantity data be included the predetermined range (threshold range) with reference to the state quantity data to be determined and the number of estimation state quantity data be not included the predetermined range and compares these numbers.

If the number of estimation state quantity data be included the predetermined range is more than the number of estimation state quantity data be not included the predetermined range (S14: YES), the control unit 60 of the determination device 6 determines that unauthorized processing is absent (normal) (S15). If the number of estimation state quantity data be included the predetermined range is more than the number of estimation state quantity data be not included the predetermined range, the control unit 60 determines that unauthorized processing has not occurred through the processing until the state quantity data to be determined is acquired, that is, the state quantity data to be determined is normal. Examples of the absence of the unauthorized processing include facts that processing by the on-vehicle ECU 3 for outputting state quantity data to be determined is normally performed, and the state quantity data to be determined that is transmitted from the on-vehicle ECU 3 is not falsified during being transmitted. That is, the absence of the unauthorized processing means that the vehicle speed ECU 3a is normally operated, and the data transmitted from the vehicle speed ECU 3a is normally transmitted via the in-vehicle LAN 4 in the case where the state quantity data to be determined is data on the vehicle speed.

If the number of estimation state quantity data be included the predetermined range is less than (not more than) the number of estimation state quantity data be not included the predetermined range (S14: NO), the control unit 60 of the determination device 6 determines that unauthorized processing is present (abnormal) (S141). If the number of estimation state quantity data be included the predetermined range is less than the number of estimation state quantity data be not included the predetermined range, the control unit 60 determines that unauthorized processing has occurred through the processing until the state quantity data to be determined is acquired, that is, the state quantity data to be determined is abnormal. Examples of the presence of the unauthorized processing include facts that the on-vehicle ECU 3 for outputting the state quantity data to be determined performs unauthorized processing due to being attacked by a computer virus or the like or the state quantity data to be determined that is transmitted from the on-vehicle ECU 3 is falsified by another unauthorized on-vehicle ECU 3 during being transmitted.

The control unit 60 of the determination device 6 completes the series of processing after execution of the processing at step S15 or S141. Alternatively, the control unit 60 of the determination device 6 may execute loop processing in order to execute the processing at step S10 after execution of the processing at step S15 or S141.

In the present embodiment, though the control unit 60 of the determination device 6 is configured to determine the correctness of the state quantity data to be determined (the presence or absence of unauthorized processing) based on the number of estimation state quantity data be included the predetermined range, the determination method is not limited thereto. The control unit 60 of the determination device 6 may derive the probability on the correctness of the state quantity data to be determined based on the number of estimation state quantity data be included the predetermined range and the number of estimation state quantity data be not included the predetermined range.

In the present embodiment, though the control unit 60 of the determination device 6 is configured to perform processing at S12 onward in response to reception of the state quantity data to be determined as a trigger and determine the correctness of the state quantity data to be determined (the presence or absence of unauthorized processing), the determination timing is not limited thereto. The control unit 60 of the determination device 6 may acquire multiple state quantity data to be compared and state quantity data to be determined at a predetermined cycle and may determine every cycle the correctness of the state quantity data to be determined based on these acquired data.

### Embodiment 2

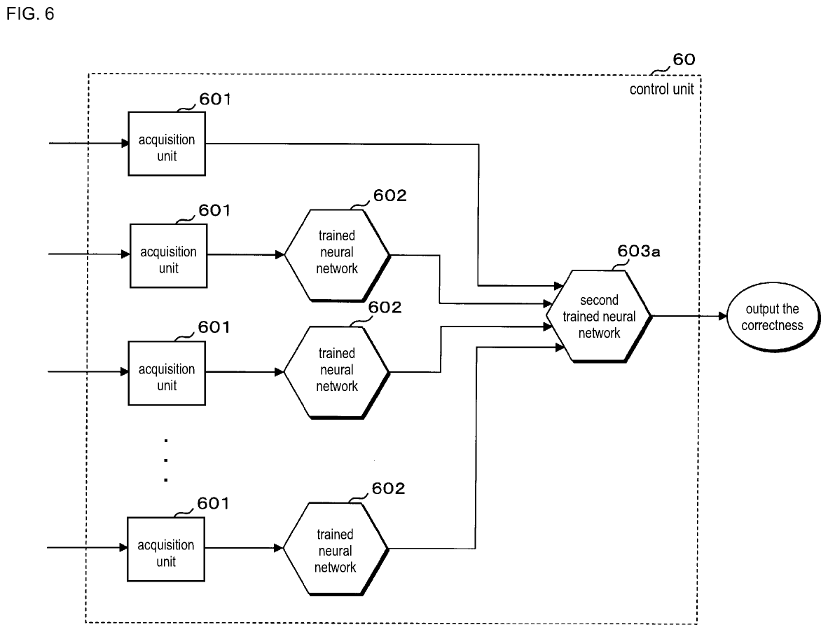

FIG. 6 is a functional block diagram illustrating functional parts included in a control unit 60 of a determination device 6 according to Embodiment 2 (second trained neural network 603a).

The determination device 6 of Embodiment 2 is different from the determination device 6 of Embodiment 1 by the rule-based processing in that the determination unit 603 is a second trained neural network 603a.

The determination device 6 of Embodiment 2 has a similar configuration to the determination device 6 of Embodiment 1 (see FIG. 2), and the configuration of the hardware such as the control unit 60, the storage unit 61, the in-vehicle communication unit 63, etc. are similar to the configuration of those of Embodiment 1.

In the functional parts included in the control unit 60 of the determination device 6 of Embodiment 2, the determination unit 603 for determining whether the state quantity data to be determined is correct or not includes the second trained neural network 603a, and the control unit 60 functions as the second trained neural network 603a by executing the control program of Embodiment 2. The functional parts other than determination unit 603, that is, the acquisition unit 601 and the trained neural network 602 for estimating the estimation state quantity data are similar to those of Embodiment 1.

The second trained neural network 603a is so trained as to estimate the correctness of the state quantity data to be determined if the state quantity data to be determined and the estimation state quantity data are input.

As illustrated in FIG. 6, to the second trained neural network 603a, the state quantity data to be determined such as a vehicle speed and the estimation state quantity data respectively estimated by the multiple trained neural networks 602 are input. The second trained neural network 603a estimates the correctness of the state quantity data to be determined based on the state quantity data to be determined and the respective estimation state quantity data that are input and outputs the correctness of the estimated state quantity data to be determined as a determination result. The estimation, though is not limited to the correctness of the state quantity data to be determined, may include the probability on the correctness of the state quantity data to be determined.

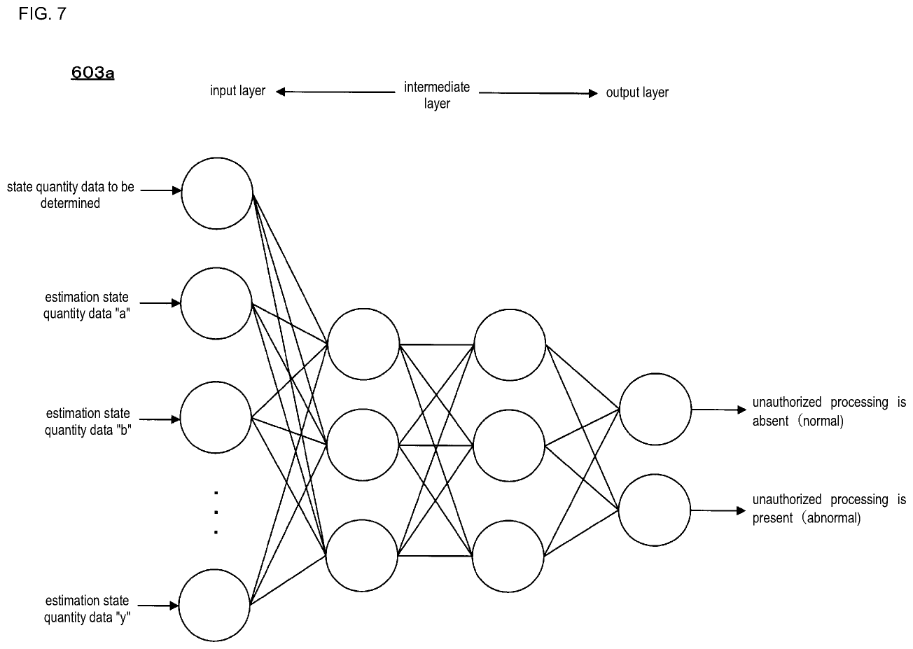

FIG. 7 is an illustrative view of one aspect of the second trained neural network 603a. The second trained neural network 603a is a deep neural network including an input layer, an intermediate layer and an output layer similarly to the trained neural network 602. The second trained neural network 603a may be a recurrent neural network including an autoregressive layer in the intermediate layer.

The input layer is composed of nodes having a number corresponding to the number of state quantity data to be determined and the number of multiple estimation state quantity data. The intermediate layer is composed of multiple layers including a fully connected layer and an autoregressive layer, for example. The output layer is composed of two nodes, for example. These two nodes may include a node that fires if it is estimated that the state quantity data to be determined is normal (unauthorized processing is absent) and a node that fires if it is estimated that the state quantity data to be determined is abnormal (unauthorized processing is present).

The teacher data input for training the second trained neural network 603a is formed of a dataset of state quantity data to be determined and multiple estimation state quantity data as a problem and data indicating the correctness of the state quantity data to be determined as an answer. The teacher data can be generated from data acquired based on actual traveling of a vehicle or data as a simulation result, for example.

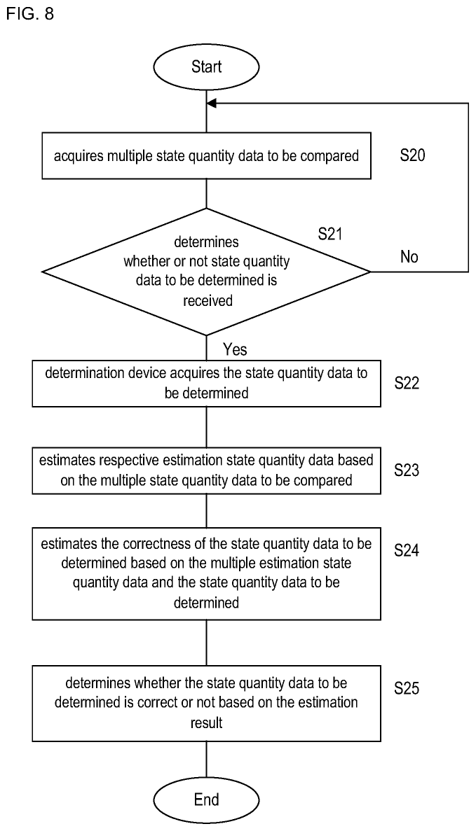

FIG. 8 is a flowchart showing processing performed by the control unit 60 of the determination device 6. The control unit 60 of the determination device 6 constantly executes the following processing in the state where the vehicle C starts similarly to Embodiment 1.

The control unit 60 of the determination device 6 performs processing (S20, S21, S22, and S23) similarly to the processing of Embodiment 1 (S10, S11, S12 and S13).

The control unit 60 of the determination device 6 estimates the correctness of the state quantity data to be determined based on the multiple estimation state quantity data and the state quantity data to be determined (S24). The control unit 60 performs processing of inputting multiple estimation state quantity data and state quantity data to be determined to the second trained neural network 603a and estimating the correctness of the state quantity data to be determined using the second trained neural network 603a.

The control unit 60 of the determination device 6 determines whether the state quantity data to be determined is correct or not based on the estimation result (S25). The control unit 60 determines the correctness of the state quantity data to be determined (the presence or absence of unauthorized processing) based on the estimation result of the second trained neural network 603a. The use of the second trained neural network 603a enables accurate determination of the correctness of the state quantity data to be determined.

The control unit 60 of the determination device 6 completes the series of processing after execution of the processing at step S25. Alternatively, the control unit 60 of the determination device 6 may execute loop processing in order to execute the processing at step S20 after execution of the processing at step S25.

It is to be understood that the embodiments disclosed here is illustrative in all respects and not restrictive. The scope of the present disclosure is defined by the appended claims, and all changes that fall within the meanings and the bounds of the claims, or equivalence of such meanings and bounds are intended to be embraced by the claims.

1. A determination device acquiring first data and a plurality of second data that are related to a state of a vehicle, comprising:
a plurality of trained neural networks that are so trained as to estimate assumption data corresponding to the first data if any one of the plurality of second data is input; and
a determination unit that determines correctness of the first data based on the estimation data respectively estimated by the plurality of trained neural networks and the first data.

2. The determination device according to claim 1, wherein an absolute value of a correlation coefficient of each of the plurality of second data and the first data is equal to or larger than a predetermined value.

3. The determination device according to claim 2, wherein the predetermined value of the absolute value of the correlation coefficient of each of the plurality of second data and the first data is 0.7.

4. The determination device according to claim 1, wherein
the determination unit
determines that the first data is normal if the number of estimation data be included a predetermined range with reference to the first data is more than the number of estimation data be not included the predetermined range and
determines that the first data is abnormal if the number of estimation data be included the predetermined range is less than the number of estimation data be not included the predetermined range.

5. The determination device according to claim 1, wherein the determination unit determines a probability of correctness of the first data based on the number of estimation data be included a predetermined range with reference to the first data and the number of estimation data be not included the predetermined range.

6. The determination device according to claim 1, wherein the determination unit includes a second trained neural network that is so trained as to estimate correctness of the first data if the first data and estimation data respectively estimated by the plurality of trained neural networks are input.

7. The determination device according to claim 1, wherein the first data is a speed of the vehicle.

8. A determination program causing a computer to execute processing of:
acquiring first data and a plurality of second data that are related to a state of a vehicle;
inputting, if any one of the plurality of second data is input, the plurality of second data acquired to a plurality of trained neural networks that are so trained as to estimate estimation data corresponding to the first data; and
determining correctness of the first data based on the estimation data respectively estimated by the plurality of trained neural networks and the first data.

9. A determination method, comprising:
acquiring first data and a plurality of second data that are related to a state of a vehicle;
inputting, if any one of the plurality of second data is input, the plurality of second data acquired to a plurality of trained neural networks that are so trained as to estimate estimation data corresponding to the first data; and
determining correctness of the first data based on the estimation data respectively estimated by the plurality of trained neural networks and the first data.

10. A method of generating a neural network model, comprising:
acquiring teacher data including a plurality of types of second data related to a state of a vehicle and first data related to a state of the vehicle corresponding to each of the second data; and
based on teacher data for each combination between second data and first data corresponding to the second, generating for each combination a neural network model that is so trained as to output estimation data related to corresponding first data if second data is input.

11. The method of generating a neural network model according to claim 10, wherein a plurality of the neural network models generated are connected in parallel to each other in order that the first data and estimation data to be respectively output are compared with each other.

12. The method of generating a neural network model according to claim 10, wherein the teacher data includes the first data and second data having an absolute value of a correlation coefficient relative to the first data equal to or larger than a predetermined value.
